(19) United States
(12) Patent Application Publication
(10) Pub. No.: US 2026/0241291 A1
(43) Pub. Date: Aug. 20, 2026

(54) SYSTEM, PARAMETER DETERMINATION METHOD, AND PROGRAM

(71) Applicant: SONY INTERACTIVE ENTERTAINMENT INC., Tokyo (JP)

(72) Inventor: Akihiro Takano, Tokyo (JP)

(73) Assignee: SONY INTERACTIVE ENTERTAINMENT INC., Tokyo (JP)

(21) Appl. No.: 19/149,105

(22) PCT Filed: Feb. 17, 2023
(86) PCT No.: PCT/JP2023/005651

§ 371 Date: Jul. 18, 2025

(51) Int. Cl. A63F 13/655; A63F 13/533; G06N 3/0475; G06N 3/08

(52) U.S. Cl. CPC A63F 13/655; A63F 13/533; G06N 3/0475; G06N 3/08

(57) ABSTRACT

Provided is a system for providing a user with an application in which an object is displayed, the system including one or more memories for storing a program code and one or more processors for executing an operation in accordance with the program code. The operation includes generating an intermediate output with use of a generative model from an image input by the user and determining one or more parameters related to an appearance of the object on the basis of the intermediate output.

### TECHNICAL FIELD

The present invention relates to a system, a parameter determination method, and a program.

### BACKGROUND ART

There is known a technology of creating, on the basis of the appearance of a user, a character of a game to be played by the user. For example, PTL 1 discloses a technology of performing a landmark detection operation on a two-dimensional image, determining weightings for each of classifications of facial features obtained with use of landmarks, on the basis of relative distances of the landmarks, and generating a three-dimensional facial model on the basis of a three-dimensional face template with three-dimensional parameters corresponding to the classifications of the facial features and the determined weightings. Further, PTL 2 discloses a technology of generating a first character that appears in a game, with use of a face model of a player generated on the basis of a face image, causing the first character to perform a predetermined action on the basis of an input made by the player, capturing an image including the first character and a second character prepared in advance as a character that appears in the game, and saving the captured image. By creating a game character on the basis of the appearance of a user as described above, effects that the user feels a sense of affinity with the character and that immersion of the user in the game is enhanced are expected.

### CITATION LIST

### Patent Literature

[PTL 1] Japanese Patent Laid-open No. 2020-177615

[PTL 2] Japanese Patent Laid-open No. 2022-68550

### SUMMARY

### Technical Problem

It is an object of the present invention to make further improvement in creating an object in a virtual space on the basis of an input made by a user as described above.

### Solution to Problem

According to a viewpoint of the present invention, there is provided a system for providing a user with an application in which an object is displayed, the system including one or more memories for storing a program code, and one or more processors for executing an operation in accordance with the program code. The operation includes generating an intermediate output with use of a generative model from an image input by the user, and determining one or more parameters related to an appearance of the object on the basis of the intermediate output.

According to another viewpoint of the present invention, there is provided a parameter determination method for determining one or more parameters related to an appearance of an object to be displayed in an application, the parameter determination method including, by an operation executed by a processor in accordance with a program code stored in a memory, generating an intermediate output with use of a generative model from an image input by the user; and
determining one or more parameters related to an appearance of the object on the basis of the intermediate output.

According to still another viewpoint of the present invention, there is provided a program for determining one or more parameters related to an appearance of an object to be displayed in an application, in which an operation executed by a processor in accordance with the program includes generating an intermediate output with use of a generative model from an image input by the user, and determining or more parameters related to an appearance of the object on the basis of the intermediate output.

### BRIEF DESCRIPTION OF DRAWINGS

FIG. 1 is a view depicting an example of a system according to an embodiment of the present invention.

FIG. 2 is a diagram depicting an example of a configuration of a computer illustrated in FIG. 1.

FIG. 3 is a diagram depicting an example of a functional configuration of the computer illustrated in FIG. 1.

FIG. 4 is a flowchart depicting a first example of an operation of the system according to the embodiment of the present invention.

FIG. 5 is a flowchart depicting a second example of the operation of the system according to the embodiment of the present invention.

### DESCRIPTION OF EMBODIMENTS

Hereinafter, some embodiments of the present invention will be described in detail with reference to the attached drawings. Note that, in the present specification and drawings, constituent elements having substantially the same functional configurations are denoted by the same reference signs, and the description will not be repeated.

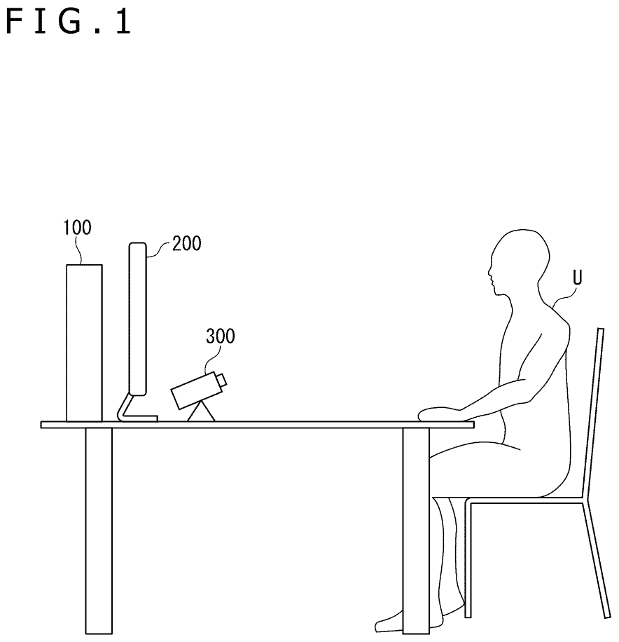

FIG. 1 is a view depicting an example of a system according to an embodiment of the present invention. In the example depicted in FIG. 1, the system for providing a user U with a game in which a character appears includes a computer 100, a display 200, and a camera unit 300. The computer 100 is a device that includes a processor and a memory, such as a game device or a personal computer (PC), for example. The computer 100 acquires an operation input made by the user U, by using, for example, an unillustrated mouse, an unillustrated keyboard, an unillustrated game controller, or an unillustrated touch panel which is provided in the display 200. Functions of the computer 100 may be distributed in a plurality of devices to be implemented. Specifically, for example, at least some of the functions of the computer 100 may be implemented by a server device on a network.

The display 200 is connected to the computer 100 via a cable, wireless communication, or the network or incorporated in the computer 100, and displays an image according to control by the computer 100. For the display 200, a flat display using a liquid crystal display (LED) or organic electroluminescence (EL), a wearable display, a projector, or the like, for example. The camera unit 300 is also connected to the computer 100 via a cable, wireless communication, or the network or incorporated in the computer 100, and displays an image including the user U as a subject according to control by the computer 100. Note that, in a case where an image that has already been saved is used as an image of the user U, as in an example to be described later, the system may not include the camera unit 300.

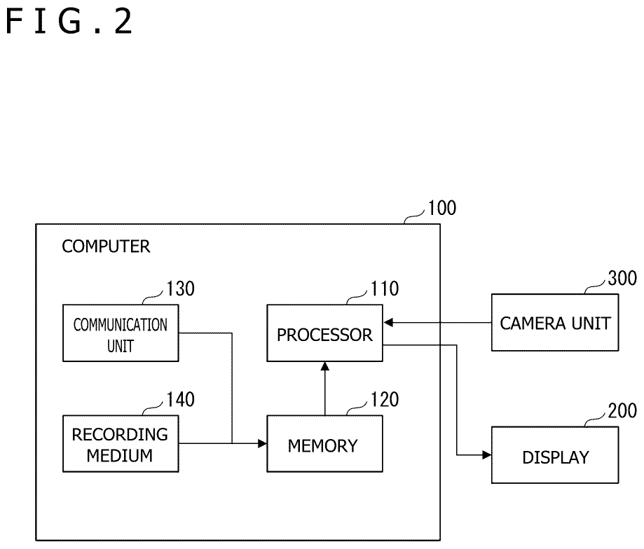

FIG. 2 is a diagram depicting an example of a configuration of the computer illustrated in FIG. 1. The computer 100 includes a processor 110 and a memory 120. The processor 110 includes a processing circuit such as a central processing unit (CPU), a digital signal processor (DSP), an application specific integrated circuit (ASIC), or a field-programmable gate array (FPGA), for example. The memory 120 includes a memory unit or a storage unit such as various types of read only memories (ROMs), random access memories (RAMs), or hard disk drives (HDDs), for example. The processor 110 operates in accordance with a program code stored in the memory 120. The computer 100 may further include a communication unit 130 and a recording medium 140. The program code may be received from an external device via the communication unit 130, or may be read from the recording medium 140 and stored in the memory 120. The recording medium 140 includes a semiconductor memory, a magnetic disk, an optical disc, a magneto-optical disc, or the like, for example. As described above, the functions of the computer 100 may be distributed in a plurality of devices to be implemented. In this case, constituent elements such as the processor 110 and the memory 120 described above are included in the plurality of devices that implement the functions of the computer 100.

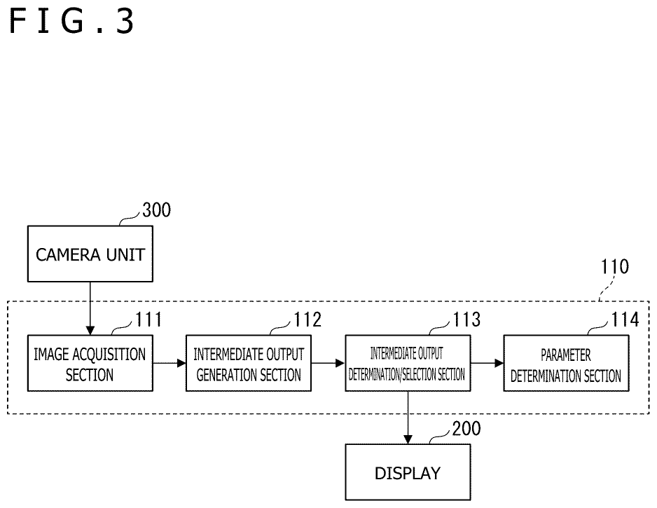

FIG. 3 is a diagram depicting an example of a functional configuration of the computer illustrated in FIG. 1. The computer 100 includes, as functions implemented by the processor 110 operating in accordance with the program code stored in the memory 120, an image acquisition section 111, an intermediate output generation section 112, an intermediate output determination/selection section 113, and a parameter determination section 114. Hereinafter, each of the functions is further described.

The image acquisition section 111 controls the camera unit 300 connected to the computer 100 and acquires an image of the user U captured by the camera unit 300. Alternatively, the image acquisition section 111 may acquire the image of the user U that has already been saved in the memory 120, according to an operation input made by the user U, or may acquire the image automatically. Note that the image of the user U may be acquired not from the memory 120 but from storage on the network. Further, as in an example to be described later, the image acquisition section 111 may capture a plurality of images of the user U by using the camera unit 300, or may acquire a plurality of saved images of the user U.

The intermediate output generation section 112 uses a generative model to generate an intermediate output from an image input by the user U with use of the image acquisition section 111. Specifically, the generative model includes a generative adversarial network (GAN), a variational autoencoder (VAE), a diffusion model, or the like, for example. The generative model used by the intermediate output generation section 112 in the present embodiment has been trained to generate an image which is a two-dimensional image as with the image of the user U and which reflects a parameters of a three-dimensional model of a game character to eventually be generated. As in an example to be described later, the generative model used by the intermediate output generation section 112 may be trained to generate a plurality of intermediate outputs from one image. Alternatively, in a case where the image acquisition section 111 acquires a plurality of images of the user U, the intermediate output generation section 112 may generate a plurality of intermediate outputs from each of the images.

Here, the above-described generative model used by the intermediate output generation section 112 is trained by using, as training data, an image (for example, a screenshot) of an existing character in a game or a character generated by setting a random parameter with use of a game character generation function, for example. A parameter related to the appearance of the character whose image is used as training data is known, so that the generative model can represent a relation between the appearance of the character and the parameters by training. Further, for example, conditioning may be performed by a text encoder in a diffusion model to train the generative model with use of a pair of text data and an image.

The intermediate output determination/selection section 113 determines, according to an operation input made by the user U, whether or not to use the intermediate output acquired by the intermediate output generation section 112 to generate the parameter of the three-dimensional model of the game character. Alternatively, the intermediate output determination/selection section 113 determines, according to an operation input made by the user U, an intermediate output to be used for generating the parameter, among the plurality of intermediate outputs generated by the intermediate output generation section 112. In the former case, the intermediate output determination/selection section 113 displays the intermediate output as an image on the display 200 to present it to the user U and acquires an operation input indicating whether or not the user U having referred to the displayed image approves the intermediate output. In the latter case, the intermediate output determination/selection section 113 displays the plurality of intermediate outputs as images on the display 200 to present them to the user U and acquires an operation input for selecting the intermediate input by the user U having referred to the displayed images.

The parameter determination section 114 determines, according to the determination or the selection by the intermediate output determination/selection section 113, one or more parameters related to the appearance of the game character on the basis of the intermediate input acquired by the intermediate output generation section 112. More specifically, for example, the parameter determination section 114 includes an estimator using a convolutional neural network (CNN), a part classifier, or the like. The parameters related to the appearance of the game character represent, in the case of a humanoid character, for example, a facial contour, arrangement and sizes of eyes, a nose, a mouth, and the like, a hair style, color of an iris, color of skin, and the like, and include a classification value for a pattern prepared in advance, an attribute value such as a hue, saturation, and brightness, and the like.

In general, a game character is deformed from a real human shape even if the game character is a humanoid, in order to facilitate handling of the game character from the viewpoint of asset management, a collision detection, drawing of facial expressions, and the like, and, in many cases, clothes and hairstyle of the game character are different from those of a real human due to the game's world design. Thus, it is difficult to naturally represent the real appearance of the user U as a game character. In other words, since the parameters related to the appearance of the game character are optimized for the handling described above, even in a case where the image of the user U is used as the input, it is not easy to determine the parameters of the game character that reduces the user U's sense of discomfort.

In view of the above, in the present embodiment, the intermediate output generation section 112 uses a generative model to generate an intermediate output from an image of the user U, the user U checks the intermediate output, and thereafter, the parameter determination section 114 determines a parameter on the basis of the intermediate output. The intermediate output is checked by the user U, so that it is possible to determine the parameter in such a manner as to reduce the user U's sense of discomfort with respect to the appearance of the character.

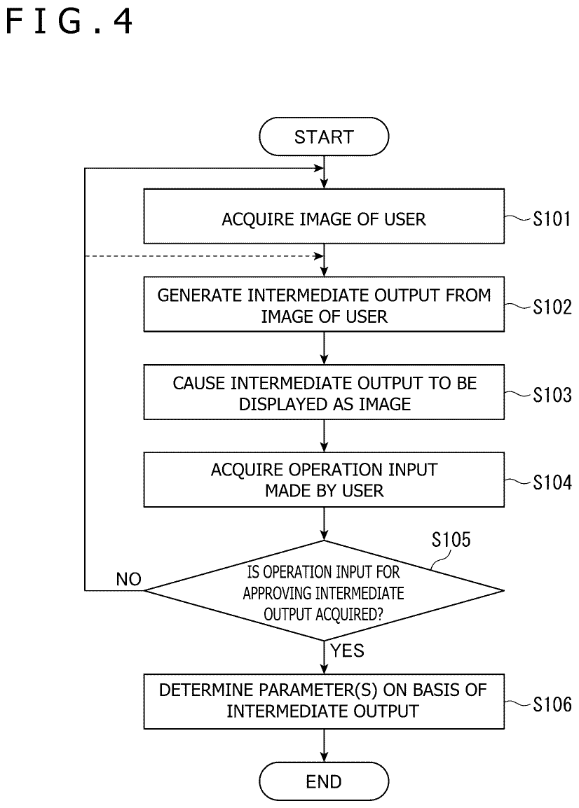

FIG. 4 is a flowchart depicting a first example of an operation of the system according to the embodiment of the present invention. The operation in the example described below may be executed as an initial setting of a game provided by the system, for example.

In the example depicted in FIG. 4, first, the image acquisition section 111 acquires an image of the user U (step S101). The image acquisition section 111 may control the camera unit 300 to capture an image of the user U, or may acquire an image of the user U saved in the memory 120 or the like, for example.

Next, the intermediate output generation section 112 generates an intermediate output from the acquired image of the user U (step S102). As described above, the intermediate output generation section 112 inputs image data of the user U to a trained generative model to generate an intermediate output. In the case of the depicted example, the intermediate output generation section 112 generates one intermediate output from one image of the user U.

Subsequently, the intermediate output determination/selection section 113 causes the display 200 to display the intermediate output as the image (step S103), and acquires an operation input made by the user U having referred to the displayed image (step S104). In a case where the operation input for approving the intermediate output is acquired (YES in step S105), the parameter determination section 114 determines one or more parameters related to the appearance of a game character on the basis of the intermediate output (step S106). In a case where the operation input for approving the intermediate output is not acquired or the operation input for disapproving the intermediate output is acquired (NO in step S105), the image acquisition section 111 acquires an image of the user U again (step S101). Alternatively, generation of the intermediate output (step S102) may be performed again with use of the same image of the user U. In this case, the intermediate output generation section 112 includes a plurality of trained generative models which are usable, and, in the second and subsequent rounds of generation of the intermediate output, generates an intermediate output using a trained generative model which is different from the one used in the previous round.

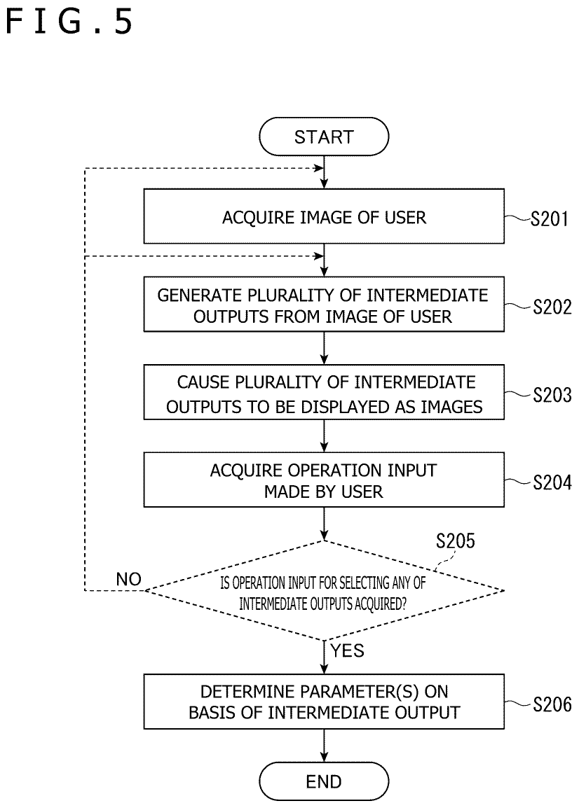

FIG. 5 is a flowchart depicting a second example of the operation of the system according to the embodiment of the present invention. In the example depicted in FIG. 5, first, the image acquisition section 111 acquires an image of the user U (step S201), as in the example of FIG. 4. Next, the intermediate output generation section 112 generates a plurality of intermediate outputs from the acquired image of the user U (step S202). In the example depicted in FIG. 5, the generative model used by the intermediate output generation section 112 has been trained to generate a plurality of intermediate outputs from one image. Alternatively, the image acquisition section 111 may acquire a plurality of images of the user U in step S201, and the intermediate output generation section 112 may generate a plurality of intermediate outputs from a plurality of images in step S202.

Subsequently, the intermediate output determination/selection section 113 causes the display 200 to display the plurality of intermediate outputs as the images (step S203), and acquires an operation input made by the user U having referred to the plurality of images displayed (step S204). The parameter determination section 114 determines one or more parameters related to the appearance of a game character on the basis of the intermediate output selected by the operation input (step S206). Here, step S206 is performed in a case where the operation input for selecting any of the intermediate outputs (YES in step S205) is acquired, and otherwise, that is, in a case where the operation input indicating that none of the intermediate outputs is selected is acquired (NO in step S205), acquisition of the image of the user U by the image acquisition section 111 (step S201) or generation of the intermediate outputs (step S202) may be performed again.

With the operation of the system according to the present embodiment as described above, acquisition of the image of the user U is repeated until the user U approves the intermediate output, and the intermediate output to be used by the user U is selected among the plurality of intermediate outputs generated from the image(s) of the user U, making it possible to determine the parameter with use of the intermediate output that reduces a sense of discomfort for the user U.

Hereinafter, examples of parameters of the game character in the present embodiment are further described. The appearance of the game character is defined by parameters of a three-dimensional model, specifically, a classification value for a pattern and an attribute value. For example, in a case where the character is a humanoid, the parameters define a facial contour, arrangement and sizes of eyes, a nose, a mouth, and the like, a hair style, color of an iris, color of skin, and the like. Also in this case, as described above, it is difficult to represent the real appearance of the user directly as the game character, due to the deformation of the character and the game's world design. Also in a case where the character is a non-human creature or an inanimate object, it is difficult to represent the appearance of the user directly as the game character.

For example, in a case where the game character is a robot, there may be parameters related to a mechanical specification of the robot, specifically, for example, parameters defining the number or sizes of components such as antennas and sensors, the luster of a housing, the number and arrangement of cables, and the like. It is possible to determine these parameters on the basis of characteristics of the hairstyle and skeleton of the user, for example. However, since such conversion is not performed in general, it is not easy to determine parameters in such a manner as to generate a robot character that makes the user feel as “being like herself/himself. ” In view of this, if an image of a human equipped with robotic components and whose skin color resembles the color of a housing of a robot, for example, is generated as an intermediate output and parameters are determined on the basis of the intermediate output approved or selected by the user, it is possible to generate a robot character that makes the user feel as “being like herself/himself.”

Further, for example, in a case where the game character is an animal or a fictional creature such as an alien, there may be parameters related to morphological characteristics of the animal or the fictional creature, specifically, for example, parameters defining the position and the shape of ears of the animal, the number of whiskers of the animal, how hairy the animal is, the number of fangs of the animal, and alignment of teeth of the animal, texture of skin of the alien, the number of eyes of the alien, and the shape of the head of the alien, and the like. It is possible to determine these parameters on the basis of characteristics of the user, such as the shape of the ears, thickness of beards, the size of a canine tooth, alignment of teeth, sizes of eyes, and shape of the head, for example. However, as with the case of the robot, it is not easy to determine parameters in such a manner as to generate an animal character or an alien character that makes the user feel as “being like herself/himself.” In view of this, if an image of a creature that is a half-human and half-animal/alien, for example, is generated as an intermediate output and parameters are determined on the basis of the intermediate output approved or selected by the user, it is possible to generate a robot character that makes the user feel as “being like herself/himself.”

Further, according to still another embodiment of the present invention, £ an intermediate output generated by the intermediate output generation section using a generative model may be used to determine parameters related to the appearances of characters in a plurality of games. For example, in a case where the system provides, to the user, a first game in which a first character appears and a second game in which a second character appears, parameters related to the respective appearances of the first character and the second character may be determined on the basis of the same intermediate model. In this case, for example, an intermediate output selected when the user has executed an initial setting of the first game is saved, and when the user thereafter executes an initial setting of the second game, the parameters of the characters are determined with use of the intermediate output that has already been saved.

In the example described above, the generative model has been trained such that the intermediate output reflects the parameters of the characters of the plurality of games, and the parameters of the characters are thus determined on the basis of the shared intermediate output across the plurality of games, making it possible to save time and effort of the user and make the characters used by the user in the plurality of games have similar appearances.

Note that, although the embodiments of the system for providing the user with the game(s) in which the character(s) appears (appear) are described above, the present invention is not limited to these embodiments and is widely applicable to a system for providing a user with an application in which an object is displayed. For example, the system may determine a parameter related to the appearance of an item other than a character appearing in a game, or may determine a parameter related to the appearance of a character or an item existing in a virtual space other than a game. In such cases, a subject of an image to be input by a user is not limited to the user himself/herself, and may be, for example, an animal such as a pet, a doll, a stuffed toy, and the like, a vehicle, personal belongings such as clothes and shoes, tools used in his/her daily life, food, plants and flowers, or the like. Further, the subject of the input image and an object for which a parameter related to the appearance is determined on the basis of the image may be of different kinds. Specifically, for example, a parameter related to the appearance of a weapon may be determined from an image of a vehicle, or a parameter related to the appearance of a character may be determined from an image of plants and flowers.

### REFERENCE SIGNS LIST

100: Computer
110: Processor
111: Image acquisition section
112: Intermediate output generation section
113: Selection section
114: Parameter determination section
120: Memory
130: Communication unit
140: Recording medium
200: Display
300: Camera unit

1. A system for providing a user with an application in which an object is displayed, the system comprising:
one or more memories for storing a program code; and
one or more processors for executing an operation in accordance with the program code, wherein the operation includes
generating an intermediate output with use of a generative model from an image input by the user, and
determining one or more parameters related to an appearance of the object on a basis of the intermediate output.

2. The system according to claim 1, wherein the generative model is trained by using, as training data, an image of another object that is displayed in the application and whose parameter related to an appearance is known.

3. The system according to claim 1, wherein the application is a game, and the object is a character who appears in the game.

4. The system according to claim 1, wherein the operation further includes
presenting the intermediate output to the user, and
determining, according to an operation input made by the user, whether to determine the one or more parameters or to generate the intermediate output from another image.

5. The system according to claim 1, wherein the generative model is configured to generate a plurality of intermediate outputs from the image, and
the operation further includes
presenting the plurality of intermediate outputs to the user, and
determining, according to an operation input made by the user, an intermediate output to be used for determining the one or more parameters, among the plurality of intermediate outputs.

6. The system according to claim 1, wherein
generating the intermediate output includes generating a plurality of intermediate outputs from a plurality of images of the user with use of the generative model, and
the operation further includes
presenting the plurality of intermediate outputs to the user, and
determining, according to an operation input made by the user, an intermediate output to be used for determining the one or more parameters, among the plurality of intermediate outputs.

7. The system according to claim 1, wherein the object includes a non-human creature or an inanimate object.

8. The system according to claim 7, wherein
the object includes a robot, and
the one or more parameters include a parameter related to a mechanical specification of the robot.

9. The system according to claim 7, wherein
the object includes an animal or a fictional creature, and
the one or more parameters include a parameter related to a morphological characteristic of the animal or the fictional creature.

10. The system according to claim 1, wherein
the system provides the user with a first application in which a first object appears and a second application in which a second object appears, and
determining the one or more parameters includes determining one or more parameters related to an appearance of the first object on a basis of the intermediate output and determining one or more parameters related to an appearance of the second object on a basis of the intermediate output.

11. A parameter determination method for determining one or more parameters related to an appearance of an object to be displayed in an application, the parameter determination method comprising:
by an operation executed by a processor in accordance with a program code stored in a memory,
generating an intermediate output with use of a generative model from an image input by a user; and
determining one or more parameters related to an appearance of the object on a basis of the intermediate output.

12. A non-transitory computer-readable storage medium storing a program which, when executed by a processor, causes the processor to perform operations comprising:
generating an intermediate output with use of a generative model from an image input by a user, and
determining one or more parameters related to an appearance of the object on a basis of the intermediate output.
